(19) United States
(12) Patent Application Publication
(10) Pub. No.: US 2011/0225015 A1
(43) Pub. Date: Sep. 15, 2011

(54) INTERACTIVE CALENDAR OF SCHEDULED WEB-BASED EVENTS

(76) Inventors: Nova Spivack, San Francisco, CA (US); Pingle Sanjay Reddy, (US); Tobias Batton, (US); Edgar Fereira, (US)

(21) Appl. No.: 13/047,607

(22) Filed: Mar. 14, 2011

Related U.S. Application Data
(60) Provisional application No. 61/313,613, filed on Mar. 12, 2010.
(60) Provisional application No. 61/331,323, filed on May 4, 2010.
(60) Provisional application No. 61/347,307, filed on May 21, 2010.
(60) Provisional application No. 61/382,013, filed on Sep. 12, 2010.

(51) Int. Cl. G06Q 10/00; G06F 17/30; G06Q 30/00

(52) U.S. Cl. 705/7.24; 707/603; 705/14.6; 707/722; 705/14.5; 707/E17.108

(57) ABSTRACT

A system for generating an interactive calendar guide to scheduled online events is described. The guide can be presented in any format, including a grid view and a list view, within various media, including at a website hosting the interactive guide and as a widget on a computer display. A user can interact with elements of the guide, select elements of the guide for more information, customize events presented in the guide, filter the results displayed in the guide, send a response to attend an event, go directly to an event from the guide, and modify the presentation format of the guide.

### CROSS-REFERENCES TO RELATED APPLICATIONS

This application claims the benefit of and incorporates by reference in their entirety the following: U.S. Provisional Application No. 61/313,613, entitled “INTERACTIVE CALENDAR OF SCHEDULED WEB-BASED EVENTS”, filed Mar. 12, 2010, U.S. Provisional Application No. 61/331,323, entitled “TEMPORAL INDICES OF THE WEB THAT ASSOCIATES INDEX ELEMENTS WITH METADATA”, filed May 4, 2010, U.S. Provisional Application No. 61/347,307, entitled “INTERACTIVE CALENDAR OF SCHEDULED WEB-BASED EVENTS AND TEMPORAL INDICES OF THE WEB THAT ASSOCIATES INDEX ELEMENTS WITH METADATA”, filed May 21, 2010, U.S. Provisional Application No. 61/382,013, entitled “INTERACTIVE CALENDAR OF SCHEDULED WEB-BASED EVENTS”, filed Nov. 17, 2010.

### BACKGROUND

Electronic program guides (EPG) display a menu that lists current and upcoming scheduling information for programs available on all channels on television and/or radio. Typically, the EPG is non-interactive and transmitted to viewers on a dedicated channel. An interactive program guide (IPG) allows television viewers and radio listeners to navigate scheduling information menus interactively. Users can select programs by station and time using an input device, for example, a television remote control.

The World Wide Web (Web) consists of interlinked hypertext documents that are accessed over the Internet. Using a web browser, text, images, sounds, videos, animations, and other multimedia content can be viewed on web pages, and hyperlinks on the web pages permit navigation between different web pages. The amount of content available over the Web is increasing extremely rapidly, and a large number of live events are available over the Web, such as webinars, product launches, and gaming events.

### BRIEF DESCRIPTION OF THE DRAWINGS

Examples of an interactive calendar of scheduled web-based events are illustrated in the figures. The examples and figures are illustrative rather than limiting.

FIG. 1A shows an example general environment in which an interactive web guide can be implemented.

FIG. 1B shows an example system for providing an interactive web guide, the system to include an interactive web guide server coupled to an event profile database, and/or a temporal index database, and/or a user database and/or an advertisement database.

FIG. 2 depicts an example page of a website providing an interactive web guide where popular web events displayed.

FIG. 3 depicts an example grid of sports-related web events provided by an interactive web guide.

FIG. 4 depicts example details provided by an interactive web guide when an event is selected from a grid of web events.

FIG. 5 depicts example web events to which the user has submitted an RSVP to the interactive web guide indicating intent to attend.

FIG. 6 depicts example search results for web events.

FIG. 7 depicts an example widget generation page of an interactive web guide website.

FIG. 8 depicts an example page of an interactive web guide website that provides size selection of a widget for the interactive web guide.

FIG. 9 depicts an example page of an interactive web guide website that provides a preview of a widget for the interactive web guide subsequent to a size selection.

FIG. 10 depicts an example page of an interactive web guide website that provides customization of a widget for the interactive web guide.

FIG. 11 depicts an example page of an interactive web guide website that provides a preview of a widget for the interactive web guide subsequent to customization.

FIG. 12 depicts an example page of an interactive web guide website that provides the software code for displaying the customized widget for the interactive web guide in an external application.

FIG. 13 depicts an example webpage that displays the interactive web guide widget.

FIG. 14 depicts a flow diagram illustrating an example process of determining the online events to be categorized as one of the “Top Picks”.

FIG. 15 depicts a flow diagram illustrating an example process of providing an interactive web guide to a user.

FIG. 16 depicts a flow diagram illustrating an example process of building a predictive analytics system for parameters related to online events.

FIG. 17 depicts a flow diagram illustrating an example process of optimizing temporal advertising on the Web.

FIG. 18 shows a diagrammatic representation of a machine in the example form of a computer system within which a set of instructions, for causing the machine to perform any one or more of the methodologies discussed herein, may be executed.

### DETAILED DESCRIPTION

The system to be presented below generates an interactive calendar guide for current and upcoming content and events available on the World Wide Web (Web) as well as online events that have recently occurred. The interactive web guide provides content to a consumer, delivers audience to event providers, and generates advertisement inventory for distribution partners.

Various aspects and examples of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the technology. Certain terms may even be emphasized below; however, any terminology intended to be interpreted in any restricted manner will be overtly and specifically defined as such in this Detailed Description section.

An interactive web guide provides information to users about scheduled events taking place online. Examples of online events include, but are not limited to video or audio streams, gaming events, tutorials, interactive chats, and podcasts. The online events can include any kind of content, such as video, audio, and/or text events. The interactive web guide provides information on events as they occur, upcoming events, as well as events that have already occurred or are recurring events. Moreover, information pertaining to online events in all time zones and in any language can be included, thus providing a central repository of online Web events.

Non-limiting examples of where the guide can be displayed include on a webpage on a computer display, within media player software (e.g., on a video player or audio player), within a virtual world, within a game platform or game environment, and within an electronic program guide on a television, set top box, digital video recorder (DVR), or digital media player.

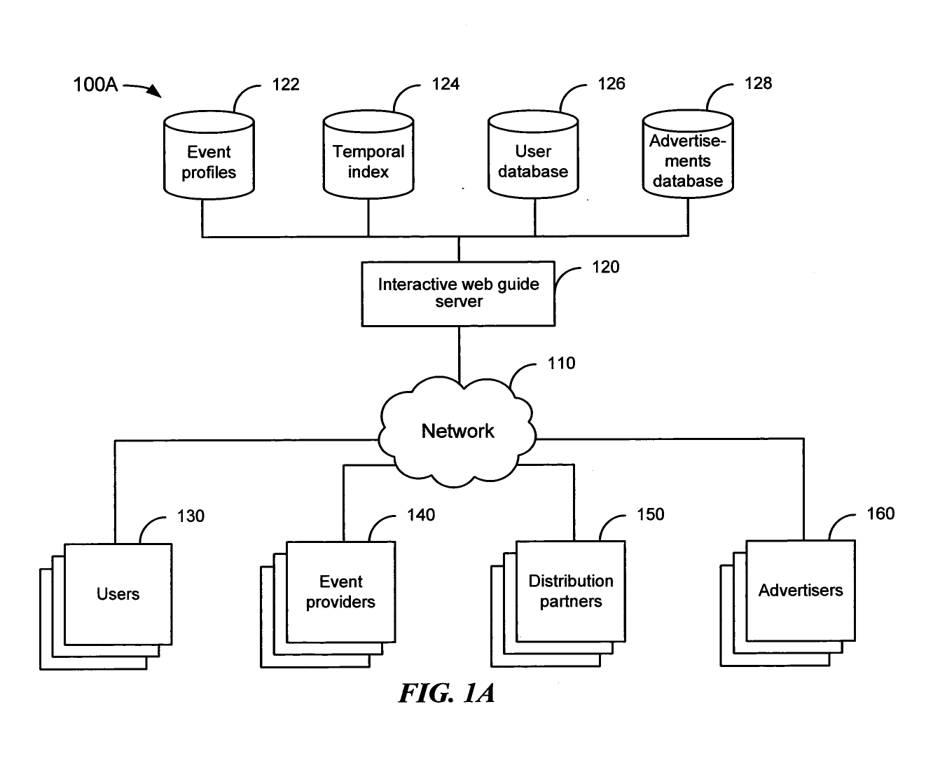

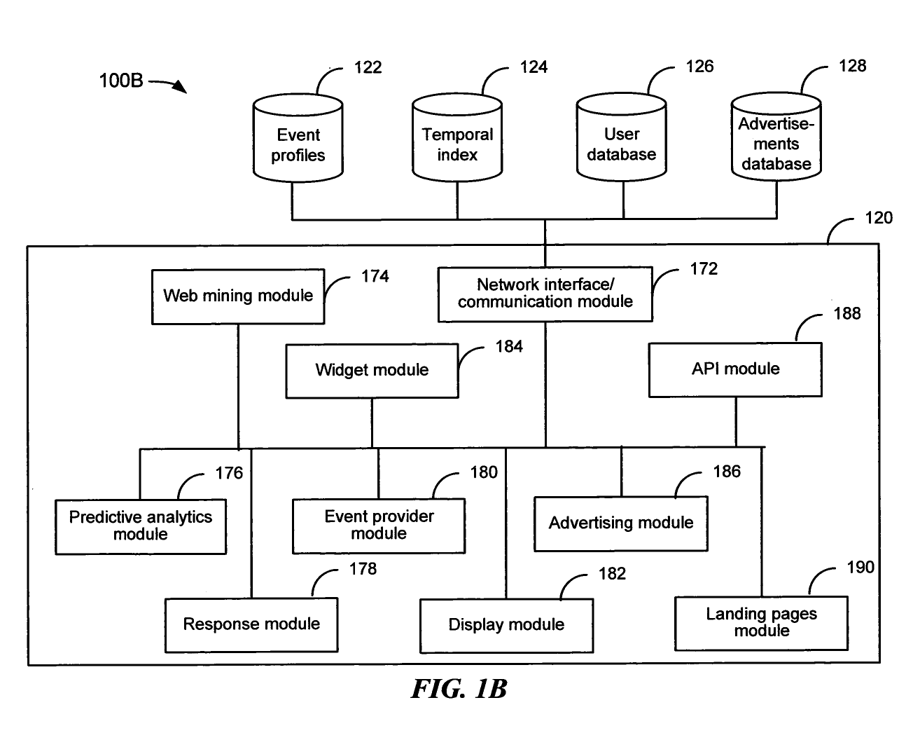

FIG. 1A shows a general environment 100A in which an interactive web guide can be implemented. A plurality of users 130, event providers 140, distribution partners 150, and advertisers 160, and an interactive web guide server 120 are coupled to a network 110. The network 110 can be an open network, such as the internet, or a private network, such as an intranet and/or the extranet. The network 110 can be any collection of distinct networks operating to provide connectivity to the users 130, event providers 140, distribution partners 150, and advertisers 160.

Users 130 access the interactive web guide to determine the events available on the Web. Event providers 140 are people or entities who provide online events, for example, YouTube, ESPN, and Infiniti. Event providers 140 can send information about their online events to the interactive web guide for presentation to users 130, and interested users 130 can attend the events, thereby broadening the audience of the event providers 140.

Advertisers 160 are entities that desire to advertise products or services to consumers, such as users 130 of the interactive web guide. Distribution partners 150 are entities that serve advertisements, for example, ESPN.com, Earthlink.net, AOL.com, and bloggers. In one embodiment, distribution partners 150 can use widgets for the interactive web guide, and advertisements in the interactive web guide are served to consumers who view the content provided by the distribution partners 150.

The event profiles database 122, temporal index database 124, user database 126, and advertisement database 128 can store information such as data, images, videos, and/or any other data item utilized by parts of the interactive web guide server 120 for operation. The event profiles database 122, temporal index database 124, user database 126, and advertisement database 128 can be managed by a database management system, for example, Oracle, DB2, or Microsoft Access.

The interactive web guide server 120 can communicate with users 130, event providers 140, distribution partners 150, and advertisers 160 via the network 110. Further, the interactive web guide server 120 can retrieve data from and add data to the event profiles database 122, temporal index database 124, user database 126, and advertisement database 128. The interactive web guide server 120 can obtain information about online events and provide the information about the online events over the network 110 to users 130.

FIG. 1B shows an example system for providing an interactive web guide, the example system to include an interactive web guide server 120 coupled to an event profiles database 122, and/or a temporal index database 124, and/or a user database 126, and/or an advertisements database 128.

In the example of FIG. 1B, the interactive web guide server 120 includes a network interface/communication module 172, a web mining module 174, a predictive analytics module 176, a response module 178, an event provider module 180, a display module 182, a widget module 184, an advertising module 186, an API module 188, and a landing pages module 190. Additional or fewer modules may be included. The interactive web guide server 120 is communicatively coupled to the event profiles database 122, the temporal index database 124, the user database 126, and/or the advertisements database 128 as illustrated in FIG. 1B. In some embodiments, the event profiles database 122, the temporal index database 124, the user database 126, and/or the advertisements database 128 are partially or wholly internal to the interactive web guide server 120.

In the example of FIG. 1B, the network interface/communications module 172 can include one or more networking devices that enable the interactive web guide server 120 to mediate data in a network 110 with an entity that is external to the server 120, through any known and/or convenient communications protocol supported by the host and the external entity. Non-limiting examples of a networking device include one or more of a network adapter card, a wireless network interface card, and a router.

In the example of FIG. 1B, the network interface/communications module 172 can also include a communications module communicatively coupled to the network 110 to manage one-way, two-way, and/or multi-way communication sessions using a plurality of communications protocols. In one embodiment, the network interface/communications module 172 receives information such as data (e.g., text, video files, etc.), commands, and requests over the network 110.

One embodiment of the interactive web guide server 120 includes a web mining module 174. The web mining module 174 can be any combination of software agents and/or hardware components able to browse the World Wide Web to search for online events and transform event data into the correct format for storage in the event profiles database. Places where the web mining module 174 searches include, but are not limited to, web pages and databases. The web mining module 174 can also return to previous locations in the Web to detect changes to event listing data.

One embodiment of the interactive web guide server 120 includes a predictive analytics module 176. The predictive analytics module 176 can be any combination of software agents and/or hardware components able to compile event data to generate a temporal index of the Web that associates two or more index elements of online events, such as location, time, and metadata. Further, the predictive analytics module 176 can use the temporal index to generate analytics data about audience demand and attendance for online events, user behavior with respect to online events, advertisements, or event ticket sales and pricing.

In one embodiment, the predictive analytics module 176 can use a predictive model to generate a predictive score for an online event over time using the predictive model and indices from the temporal index database, correlate the predictive score with an actual score after the event takes place, modify the predictive model based upon the correlation, and use the modified predictive model to dynamically price tickets and advertising for future online events.

In one embodiment, the predictive analytics module 176 can use information in the event profile database 122 and/or the temporal index database 124 to geotarget and/or geosegment the audience. This information can be used by the advertising module 186 to intelligently buy, sell, price, manage, target, and optimize online advertising campaigns.

One embodiment of the interactive web guide server 120 includes a response module 178. The response module 178 can be any combination of software agents and/or hardware components able to receive input from users through the interactive web guide and respond to the input. Input can include commands such as change the format of the displayed guide, display events under a particular tab, and go to an event. The response module 178 sends format and display changes to the display module 182. Further, the response module 178 can receive responses (RSVPs) sent by users who plan on attending an online event and store the responses in the event profiles database 122 and/or the temporal index database 124 and/or the users database 126. The response module 178 can use the responses to generate personalized schedules for each user, send event reminders, and send data to the display module 182 for presenting events to the user that the user has signed up for in a “My Events” view of the interactive web guide.

Additionally, the response module 178 is able to receive one or more filter parameters and search through the event profiles database for online events that are related to the filter parameters. Results of the filter are passed to the display module 182 for presentation to the user. Examples of filter parameters include, but are not limited to, channels, categories of events, and start time of events.

One embodiment of the interactive web guide server 120 includes an event provider module 180. The event provider module 180 can be any combination of software agents and/or hardware components able to receive data about online events from event providers and store the data in the event profiles database 122 and/or the temporal index database 124 for display in the interactive web guide.

One embodiment of the interactive web guide server 120 includes a display module 182. The display module 182 can be any combination of software agents and/or hardware components able to present an interactive web guide to the user on the user's display. The interactive web guide can have any format specified by the user or a default format, such as a grid view or a list view. The guide can include online events related to a topic specified by the user or a default set of events, such as most popular events that have been signed up for by attendees. Further, the display module 182 responds to user commands to change the way the interactive web guide is caused to be displayed, such as customizing a display of the guide, zooming in or out of a time slot, showing nested calendars for a channel within a time slot, and showing a three-dimensional view of stacked events occurring in the same time slot.

One embodiment of the interactive web guide server 120 includes a widget module 184. The widget module 184 can be any combination of software agents and/or hardware components able to receive widget customization parameters from a user and to generate software code for a customized widget that will enable the interactive web guide to be installed and executed in external Web sites, on desktops, or within other applications that accept widgets as plug-ins.

One embodiment of the interactive web guide server 120 includes an advertising module 186. The advertising module 186 can be any combination of software agents and/or hardware components able to receive advertisements for placement in the interactive web guide, use predictive analytics data from the predictive analytics module 176 to buy, sell, price, manage, target, and optimize online advertising campaigns and ticket prices for online events, and send the appropriate advertising information to the display module 182 for display in the appropriate view in the appropriate location in the interactive web guide.

One embodiment of the interactive web guide server 120 includes an API module 188. The API module 188 can be any combination of software agents and/or hardware components able to store and implement rules and specifications used to communicate with external parties and allow the external parties to access information associated with the interactive web guide, such as online event data, user profile data, and/or analytics data, buy or sell advertising within the interactive web guide, and administer advertising campaigns within interactive web guide content.

One embodiment of the interactive web guide server 120 includes a landing pages module 190. The landing pages module 190 can be any combination of software agents and/or hardware components able to generate and maintain event landing pages for event providers of online events.

In the example of FIG. 1B, the event profiles database 122 stores data related to online events including, but not limited to, start time, event location, and metadata about the event, such as pricing, duration, permitted audiences, requirements or pre-requisites, agenda, channel or brand, associated show or series, participants, hosts, guests or talent, live status, popularity, attendance, number of RSVPs received in advance, projected audience, relationships to other information or content, other events, people, organizations, places, times, topics, categories, geographic regions, organizations, brands, or concepts.

Online events can be any scheduled activity or happening on the web, such as a video stream, audio stream, auction or sale, game tournament, chat session, social event, product launch (e.g., launch of a new blog post or article), a scheduled tweet or link, podcast, etc. as well as launches of traditional products (e.g., a new computer, new sneaker line, etc.), site or content launch, contest, survey or poll, software release, feature release, news release, class, lecture or talk, conference or tradeshow, etc. Events can be free, pay per view, or available by subscription and can be accessed through the website hosting the interactive web guide or after registering at the website for certain events. Events may be open to the public or only open to specific audiences such as invited audiences or qualifying participants.

Data stored in the event profiles database 122 is obtained directly from event providers. Alternatively or additionally, a Web crawling system searches external content (web pages, databases, application programming interfaces (APIs)) for online event data and gathers that data for inclusion in the event profiles database 122. The crawler detects event data either by being aimed specifically at sites or pages that contain such data (for example, at a calendar of events on a particular website) or by using linguistic methods to crawl web sites and links to organically detect events wherever they may be referred to in structured or unstructured data found on discovered Web pages. The crawler transforms event data into a normalized event data schema and stores the data in an event profiles database 122.

In one embodiment, the crawler intelligently re-crawls locations that have previously been crawled based on the date and time of events those locations refer to. As the air-date of an event gets closer, the frequency of re-crawling increases proportionately in order to detect changes to the event listing data prior to the air-time of the event. Re-crawling can be targeted at event sites that do not provide a URL for the actual event until the event starts or until a short time before the event starts. The crawling system recognizes the start date/time of an event and intelligently re-crawls looking for that URL in order to get it prior to or simultaneously with the event start. Once an event has finished, crawling may decrease in frequency or stop for that event location URL.

In one embodiment, the event data crawler can seek and harvest several different URLs near or around an online location of an event. When a user tries to go to an event by clicking the “go to event” button or link, if the target URL for an event is not found or is not available, a user can be redirected to a nearby URL the event from one of the interactive web guide web pages, data records, widgets, applications or APIs.

For example, when the “go to event” button or link is clicked by an end-user, if the event URL is not found, go to the URL for the show the event is part of. If the URL for the show is not found, then go to the URL for the channel the event is part of. If the channel URL is not found, then go to the URL for the section of the site that event is part of. If the section URL is not found, then go to the URL for the event calendar in that site (if there is one). If the event calendar URL is not found, then go to the home page of the site that URL is part of. If the home page URL is not found, then go to the event profile page in the interactive web guide and show a message stating that the event URL was not found. Other rules for cascading URLs can be implemented.

In the example of FIG. 1B, the temporal index database 124 stores index elements of online events including, but not limited to, internet address, time information relating to the event, and metadata, such as intended audiences of events, analytics data or metrics about demand, audience, prices, or inventory related to the events, or other addresses or content of any kind related to the events Data stored in the temporal index database 124 is obtained from advertisers and the event profiles database 122.

In the example of FIG. 1B, the user database 126 stores user information including, but not limited to, events attended by a user, events that a user responded to with an RSVP, and user profile information. Data stored in the user database 126 is obtained from users of the interactive web guide.

In the example of FIG. 1B, the advertisements database 128 stores advertisements and related information including, but not limited to, advertising campaigns, pricing information, and advertiser information.

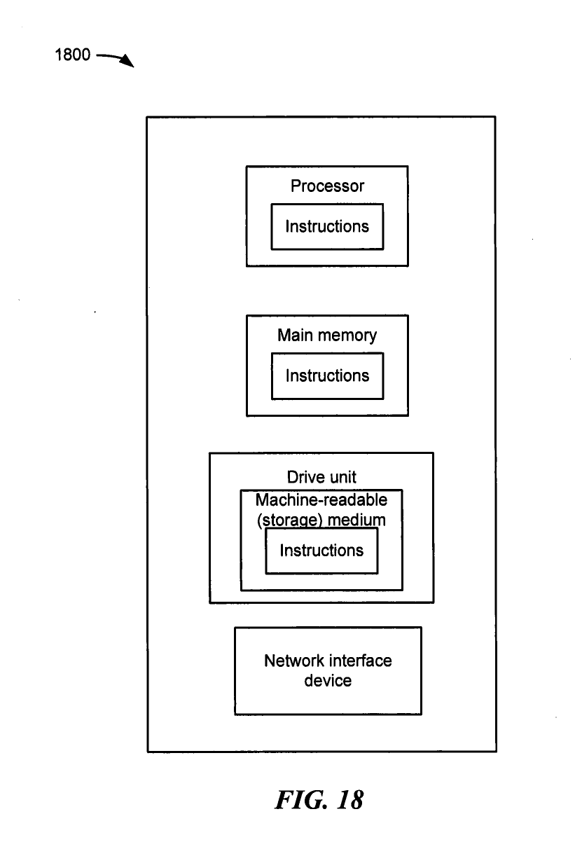

The interactive web guide server 120 can also be implemented on a known or convenient computer system, such as is illustrated in FIG. 18.

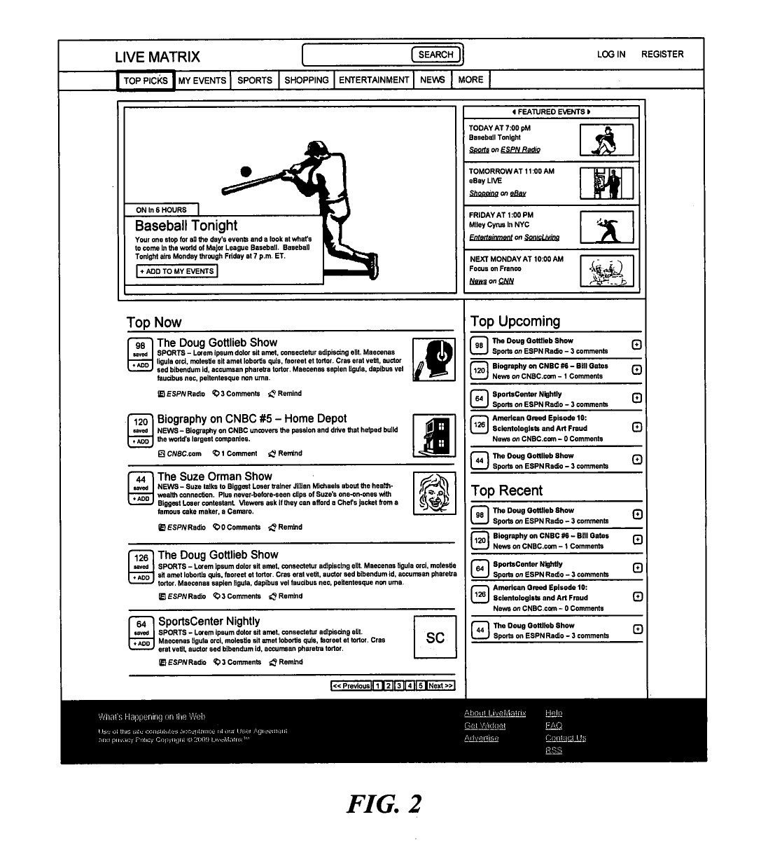

FIG. 2 depicts an example page of a website that provides access to an interactive web guide. As shown, online events categorized as “Top Picks” events are listed. “Top Picks” are events generated through the use of a ranking algorithm that orders events as a function of the number of users who have responded for attending the event (RSVP), the rate at which the RSVPs for the event are received, and/or other mathematical functions that include measures based on RSVPs to an event. The “Top Picks” can be further subdivided into groups, such as “Top Now” which are the top events presently occurring, “Top Upcoming” which are the top events scheduled to occur in the future, and “Top Recent which are the top events that have recently occurred. Each of these lists is shown in the example of FIG. 2.

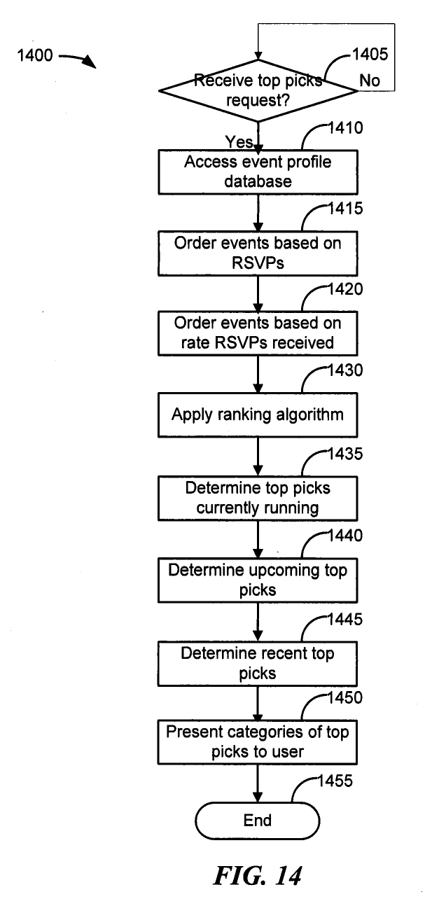

FIG. 14 depicts a flow diagram illustrating an example process 1400 of determining the online events to be categorized as one of the “Top Picks”. At decision block 1405, the system determines if a request for displaying the top picks has been received from the user. If no request has been received (block 1405—No), the process waits at decision block 1450 until a top picks request has been received. If a request has been received for top picks events (block 1405—Yes), at block 1410, the system accesses the online events stored in the event profile database.

Then at block 1415, the online events in the database are ordered based upon the number of RSVPs that have been received for each event. The more RSVPs that have been received for an event, the higher the event is ranked in the ordering of the events.

At block 1420, the online events in the database are ordered based upon the rate at which the RSVPs were received for each event. For example, if an online event received 100 RSVPs during the first week after the event was announced, it would rank lower than an event that received 200 RSVPs during the first week.

At block 1430, the system applies a ranking algorithm to the online events based at least upon the ranking of the events based upon the number of RSVPs received and the ranking of the events based upon the rate at which the RSVPs were received. In one embodiment, the rankings for each event can be summed, and the online events with the lowest total summed rankings are categorized as top picks.

At block 1435, the online events are filtered to determine which events are currently running at the time of the user request. The currently running events with the lowest total summed rankings are categorized as “Top Now” events.

At block 1440, the online events are filtered to determine which events are scheduled to play in the future within a certain time frame, for example, during the next seven days. The events with the lowest total summed rankings are categorized as “Top Upcoming” events.

At block 1445, the online events are filtered to determine which events have already occurred within a certain time frame, for example, during the past seven days. The events with the lowest total summed rankings are categorized as “Top Recent” events.

At block 1450, the online events determined to be “Top Now”, “Top Upcoming”, and “Top Recent” are presented to the user. The format in which the events are presented is either a default format or a format specified by the user. The process ends at block 1455.

In one embodiment, each online event in the “Top Picks” lists can show various elements including metadata related to the event, a clickable button for adding the event to a “My Events” list or a personal or shared calendar, and/or a reminder button that sends a reminder to the user for the event. As shown in the top left section of FIG. 2, the “Top Picks” web page of the interactive web guide can include a video carousel that displays still or video images associated with events and rotates through a set of editorially or algorithmically determined events. In one embodiment, the images can provide certain metadata about the event that the user can interact with. Additionally, the events displayed in the video carousel can be periodically refreshed.

Near the top of FIG. 2 are tabs that provide alternate views or views of subsets of the online events data in the interactive web guide, such as “My Events”, sports events, shopping events, entertainment events, news events, most popular events of the day, and events on a particular topic selectable by the user. Custom tabs or views can also be created by editors, users, or distribution partners to show or feature content related to a theme or topic of interest. For example, an event provider can show only events in channels that the event provider creates from its own content across sports, entertainment, and news, while a tab (not shown) labeled “World Cup Soccer 2010” can list channels displaying events from multiple event providers either via branded channels from a single event provider (e.g., soccer related chats from ESPN3) or from an amalgamated channel (e.g., soccer chats from multiple event providers). Views can also contain sub-views (e.g., the entertainment tab can contain sub-tabs for music, movies, TV and gaming).

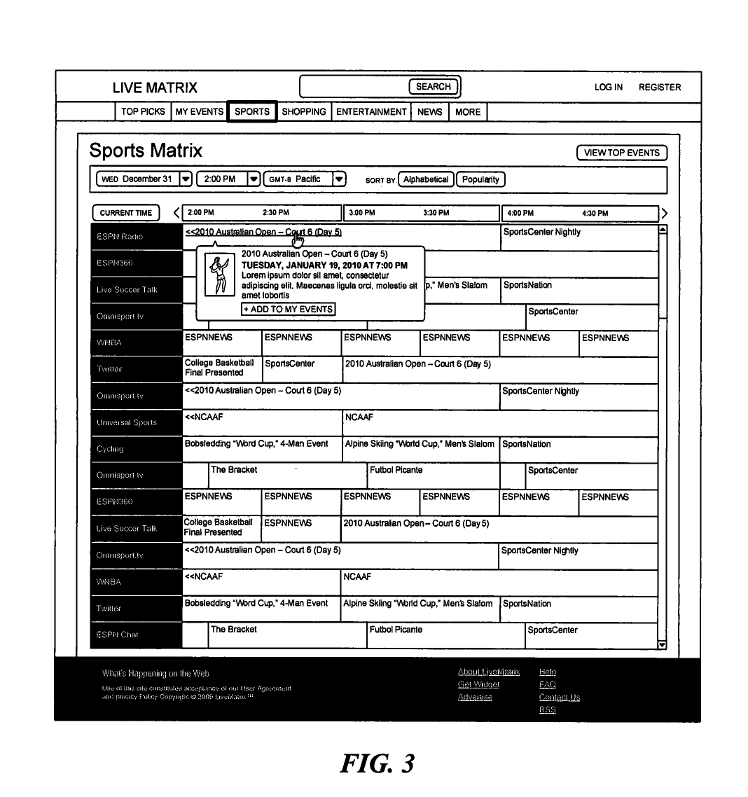

An example of a sports-related web events guide is shown in a two-dimensional grid format in FIG. 3. However, the guide can be put in any format including, but not limited to, a calendar, schedule, list, or timeline, where each format depicts a set of events that takes place on the internet, on pages within websites, or at locations within online services or applications that are connected to the Internet at various times.

In one embodiment, rows in the two-dimensional grid represent content channels, while columns in the grid represent time slots of any time unit (e.g., half hour, hour, etc.). Cells (row-column intersections) in the matrix represent events, which can be one-time or multi-episode events that take place on the Web. Events can take place in other media such as on television or the radio, or in a physical location, but the events should also take place online so that the events are available to consume and/or participate in online at a scheduled date and time. In one embodiment, events can be made available in archived form after the scheduled date and time of the event. Further, events can be linked together within or between channels and time slots. Other layouts of the grid can also be implemented.

A channel can contain any set of events, such as events associated with one or more content providers, brands, shows, and/or events related to one or more topics, events, or interest categories. In one embodiment, a channel can include an aggregation of events by one or more editors or end-users who create the channel.

In some instances, one or more additional dimensions can be added to the grid that depict other attributes of online events or related information. For example, if there is an online event that is paired with an offline television show event, and both events take place at the same time slot, a third dimension of the grid (z-axis) can show the online show occurring at the same time as the television show. In one embodiment, the display can allow the three grid dimensions to be rearranged with a click by the user so that the elements in the x- and z-axes can be interchanged, resulting in time slots being shown along the z-axis, and elements in the z-axis (e.g., offline television show) being shown along the x-axis. In addition, further dimensions can be added beyond three dimensions to show additional dimensions of information related to time, channel and events. In one embodiment, the user can rotate or reassign the axes such that the x-axis becomes the y-axis and/or the y-axis becomes the z-axis, for example.

Channels within the grid can be ordered according to a default sort order, such as alphabetically by channel name, or by current or overall popularity of each channel. In one embodiment, the user can select the order in which the channels should be ordered and displayed. Further, a channel in the grid can summarize a large number of sub-events in a time slot. The sub-events can be hierarchical events related to and within a single event taking place on that channel, or they may be separate parallel events taking place on that channel at the same or overlapping times.

In one embodiment, multiple events can be shown within a channel within a single time slot. Methods for showing multiple events include, but are not limited to, zooming in or out of the time slot, showing a nested calendar for the channel within a time slot, showing an expandable list or menu of events within a time slot, opening a channel page for the channel at a time slot and on that page showing multiple events taking place at that time, and showing a stacked view of events happening in the same time slot using the z-axis as a third dimension. Similar methods can be used with hierarchical events.

In one embodiment, a channel profile view can be displayed in the interactive web guide. The channel profile view provides a profile of a particular channel of online events, where a channel can represent events provided by a particular content provider, events about various topics or interests, or events aggregated by editors or users.

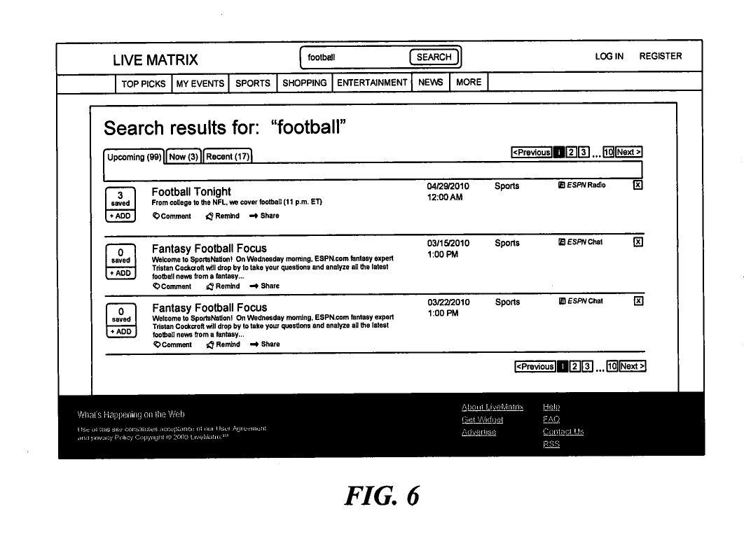

Within the grid, content can be sorted by a user according to channel name, channel popularity, show name, show popularity, price, content ratings, or any other desired attribute of channels or shows. The grid can be filtered according to any search query or particular desired attribute(s) of channels, time, and events. For example, as shown in FIG. 6, a search can be performed to find events related to a search query, such as football. The results of the search are displayed in a list format in FIG. 6. However, the results can also be displayed in a grid or any other format that includes only the results of a search for online events that match or are relevant to a search query. In one embodiment, the search results can include only the online events relevant to a user initiating the query, in response to results of a user profile. In one embodiment, results of the search query can be ranked by relevance, popularity, date, title or any other criteria. In one embodiment, the search can be modified to show only events taking place on the Internet or Web relevant to a particular time, geographic location and/or interest profile of a user. Further, the grid can be localized to show only content relevant to a specific geography. In one embodiment, the grid can automatically adjust to focus on the current time for the viewer.

Within the grid, event listings can provide summary information about the content of the event. For example, as shown in FIG. 3, events are previewed by moving a cursor over an event in the grid to see a pop-up preview that includes select metadata (such as description and/or channel) and certain actionable features such as adding the event to “My Events” or clicking to go to an event detail page provided by the interactive web guide. When an event in the grid is clicked on by a user, the user is taken to more detailed summary information about the event, or directly to the location of the event on the Web. In one embodiment, the interactive web guide can provide expandable event listings that show more information about particular events when a user selects the event, moves a cursor over the event, touches the event, gestures on the event, or clicks on the event.

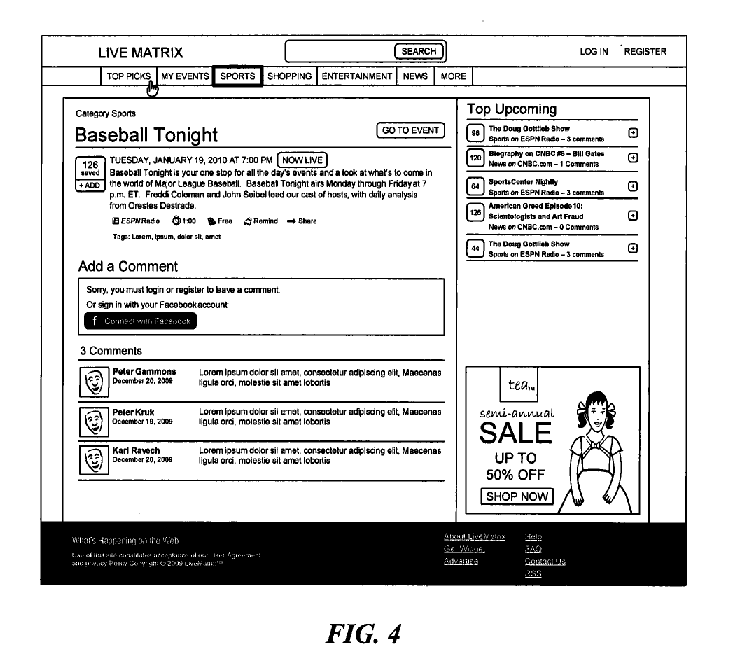

The example grid of online sports events shown in FIG. 3 has a button in the upper right corner that can be selected by a user to view top events. When a user selects this button, the top events in the sports category are displayed, as shown in the example listings in FIG. 4. The most popular upcoming event is shown in the top left corner of the website, and comments from users about this event are also provided. Further, the top upcoming sports events are listed on the right side of the webpage.

In one embodiment, the interactive guide of online event listings can display events that are color-coded or with particular graphical icons or artwork to indicate thematic content of an event, such as type of event, intended audience, popularity of event.

In one embodiment, a list view can be selected by the user to show the schedule of events taking place on websites around the world, and the list view has all the capabilities of the grid view discussed above but displays information in a list rather than a grid format.

In the list view, in one embodiment, headings are used to denote channels, and rows denote events at various time slots for those channels. In one embodiment, headings can be used to denote time slots, and rows can be used to denote channels and events taking place at those time slots. In yet another embodiment, headings denote ratings, and rows denote events at various times, on various channels, with those ratings. Other layouts of the list view can also be implemented.

Event Profiles

In one embodiment, the interactive web guide can provide detailed data and metadata about an online event, including a button or link to go to the event and a button or link to RSVP and add the event to a personal or group events schedule. In one embodiment, the interactive web guide can show other information, such as whether the event is currently taking place and real-time audience measurement (e.g., the number of present or predicted attendees). In one embodiment, the interactive web guide can show discussion about the event or related content to the event. For example, comments from users logged in and attending the online baseball event are shown in the lower left corner in FIG. 4.

Events may be clicked on to view event profile information about the events, or a user can attend an event by clicking a “go to event” link or a “play” button. When an event is played, if the event is presently occurring, the user can either be taken to the live event or the live event plays directly within the interactive web guide. If the event has already occurred, the user is taken to an archived or recorded copy of the event content, or the user is given a choice of where to watch or play the event. If the event has not yet occurred, the user is asked to set a reminder or receive a pre-set reminder. For example, pre-selected reminders can be set for 15 minutes, 30 minutes, or one hour prior to the start time of an event. Reminders can be provided to a user via email, short message service (SMS), Twitter, really simple syndication (RSS), phone call, pop-up alerts in a desktop application, alerts within the interactive web guide, or any other communications medium.

In one embodiment, events can be shared. Ways to share events include, but are not limited to, via a link or button to share with friends via email invites, within a shared calendar tool, with a recommendations tool, and sending an announcement about the event to a social network like Twitter.

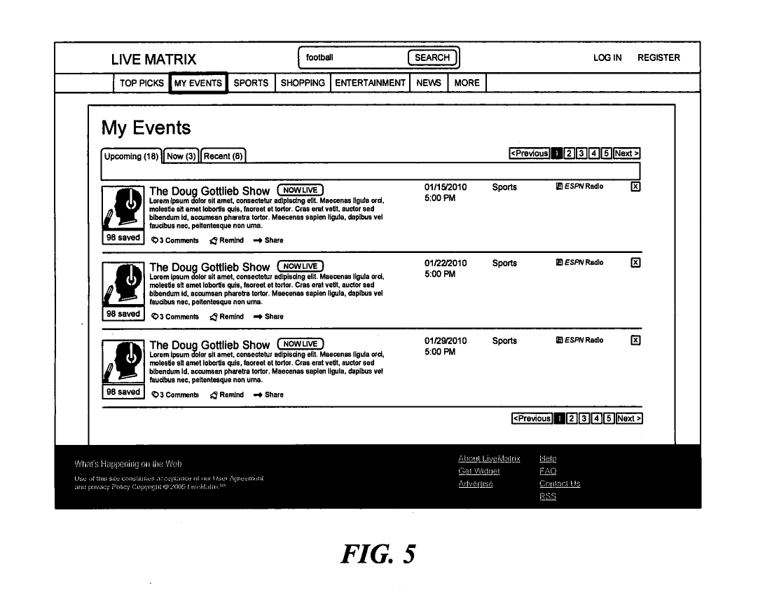

FIG. 5 depicts example web events customized to a user's interests under the selected tab “My Events”. In one embodiment, a “My Events” webpage of the interactive web guide displays online events that an individual or group has added or provided an RSVP to attend. The display can be in any format, such as a grid or list. Events can be clicked on by a user to view event profile information about the particular event. In one embodiment, the web event can be played by clicking a “go to event” link or a “play” button. When an event has been selected to be played, the user is either transferred to the website of the live event if it is presently occurring, or to an archived or recorded copy of the event content if the event has already occurred.

As with online events presented in any view such as “Top Picks” (FIG. 2) or search results (FIG. 6), events for which the user has signed up for with an RSVP can be categorized according to the time of the event: upcoming, presently occurring, and occurred in the recent past, and these events can be organized using tabs as shown in FIG. 5. Other event categories can also be implemented. The example listing in FIG. 5 shows three upcoming events for which the user has signed up for.

In one embodiment, the “My Events” view shows the status of or information about events that the user has signed up for, for example, whether the event has been watched by the user and popularity of the event. In one embodiment, the “My Events” view can show how many total events have been stored in the user's “My Events” tab and/or a breakdown of how many events have been stored that have occurred in the past, are presently occurring, or are scheduled in the future.

In one embodiment, the events in the “My Events” view can be sorted by channel, date/time, popularity, audience size, ratings, genre, media type, category, or any other parameter. A default sort order can be set, or the user can select a method of sorting.

Events can be added to a user's “My Events” view when the user clicks on a “Add to my events” button that is made available with each event listing in the interactive web guide. For example, in FIG. 3, the cursor has been moved over the event “2010 Australian Open—Court 6 (Day 5)” which brings up a pop-up window with event details and the “Add to my events” button. When a user selects the button, the corresponding online event is added to the user's personal or shared calendar. When a user adds an event to his personal calendar, the user effectively sends an RSVP to the event for themselves and/or others they represent, and the interactive web guide stores the information about the user and the event in a database. In one embodiment, reminders can be opted into or out of by the user at the time that the RSVP is sent.

Reminders can be synced automatically or manually with various calendar applications (e.g., iCal, Outlook, Google Calendar). or example, an email can be sent to a user with an iCal record attached to it for inclusion in his calendar. Alternatively, a calendar invitation can be sent to a user or automatically inserted into a linked calendar service or application with the user's permission.

Events in any view (Grid view, List view, My Events view, Top Picks, search results, or any other view) can be sorted by the user in any of a number of ways including, but not limited to, start time, end time, duration, title, price, popularity, audience size, language, geography, intended audience, content rating, user rating, user selected flags or tags, genre, category, channel, brand, show or series, media, and content type (e.g., video, audio, chat, game platform, virtual reality, web site, etc.).

Displaying the Interactive Web Guide

In one embodiment the interactive web guide of online events taking place on the Internet or Web can be displayed in any view (e.g. grid view or list view) with information about online events that are related to or relevant to television events within an electronic program guide (EPG) on a television, DVR, set-top box, or personal media player. For example, events that are taking place on the Internet that are related to an event that is taking place on television can be shown. As another example, during the live broadcast of the Superbowl, the interactive web guide can show online events related to the Superbowl that are taking place (at any time or the present time) in online locations such as uStream, Livestream, Justin.tv, YouTube, Twitter, Second Life, various web pages. In some instances, the interactive web guide can display information about television events or offline events that are associated with online events listings, within an online program guide (OPG).

In one embodiment, the interactive web guide can be displayed as a guide or grid (of online and/or offline events) in three or more dimensions using 3-D viewing technology (for example, requiring 3-D glasses on a 3-D TV or 3-D display).

In one embodiment, contextually relevant information about an event can be obtained from a database of metadata about online events listings and displayed in a frame, toolbar, pop-up area, ticker, window, picture in a picture, or information overlay, while viewing an actual event as it takes place within a Web browser, video player software, audio player software, or other media player software.

In one embodiment, an automatically recorded preview or synopsis of the most recent number of minutes (N) of a currently live online event can be displayed on an event profile page or within an interactive guide, grid or schedule of online event listings in a video thumbnail or embedded video player.

In one embodiment, recommendations for online events targeted to a particular user profile can be displayed while a user is browsing an interactive guide, grid or schedule of online events, or an online event profile page. In some instances, a set of online events can be displayed to a user, where the set of events can include events that the user's friends or other people socially connected people to the user have sent an RSVP to attend, are presently “checked into” as attendees, or have recommended to the user.

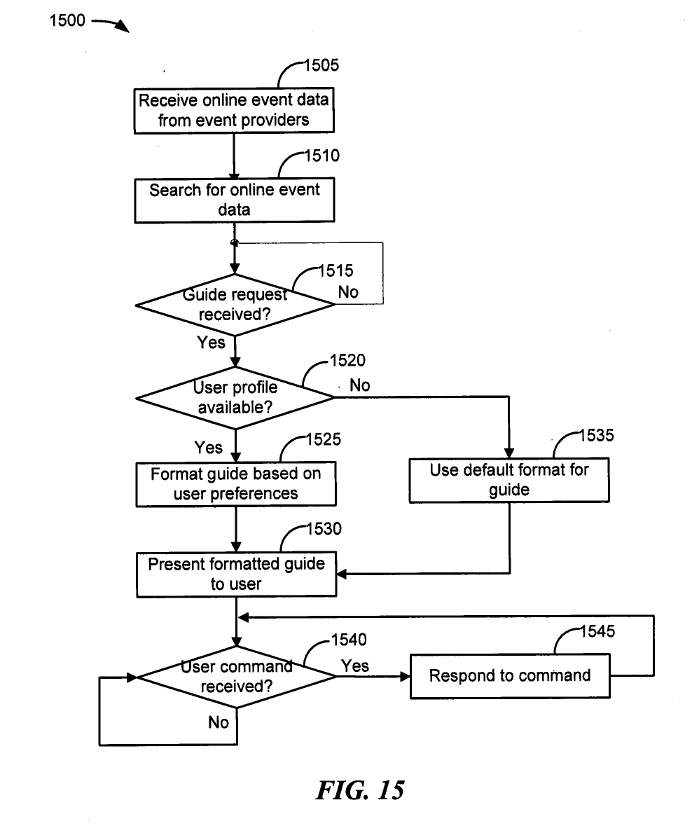

FIG. 15 depicts a flow diagram illustrating an example process 1500 of providing an interactive web guide to a user. At block 1505, the system receives online event data from event providers. Online event data can include location of the event, time of the event, and metadata relating to the event. The data is stored in the event profiles database 122 and/or the temporal index database 124.

At block 1510, the system searches for online event data over the Web using a Web crawler. Event data obtained by the crawler is stored in the event profiles database 122 and/or the temporal index database 124.

At decision block 1515, the system determines whether a request has been received for a presentation of the interactive web guide. If no request has been received (block 1515—No), the process waits at decision block 1515 until a guide request has been received. If a request has been received for the guide (block 1515—Yes), the process continues to decision block 1520.

At decision block 1520, the system determines whether a user profile is available for the requesting user. If a user profile is available (block 1520—Yes), at block 1525, the system formats the interactive web guide based on the user preferences specified in the user profile. Then at block 1530, the formatted guide is presented to the user on the user's display. If a user profile is not available (block 1520—No), at block 1535, default formatting is used for the interactive web guide, and the formatted guide is presented to the user at block 1530.

The process continues from block 1530 to decision block 1540 where the system determines if a command or request has been received from the user. If no command or request has been received (block 1540—No), the process waits at decision block 15 until a command or request has been received.

If a command or request has been received (block 1540—Yes), the system responds to the command or request and returns to decision block 1540 to await the next request or command. Examples of commands or request that the user can send include, but are not limited to, displaying top picks, sending a search request, changing the format of the guide presentation (e.g., guide view, list view, etc.), selecting an online event to obtain more information about the event, adding the event to the user's “My Events”, RSVP to an event, go to an event.

Personalized Schedules

In one embodiment, personalized calendars of past, current, and upcoming selected and/or recommended events can be provided to users. Recommendations can be based on the events for which the user has sent an RSVP and/or attended events over time. In one embodiment, recommendations can also be based on events for which an RSVP has been sent and/or attended by a user's social connections, members of various communities the user participates in, or those of other users who shave similar profile attributes to the user.

A user can create a “My Matrix” tab that is based on a combination of channels that the user has chosen from a list, a channel detail page, or anywhere within the interactive web guide where an option to add a channel is provided. Additionally, channels can be selected by a user using an interactive web guide widget. Further, the user can select from a list of channels generated by a search for key word(s). For example, the user may be interested in events related to “chess, wine, Donna Karan and gardening.” A search of those terms within the interactive web guide's database of events generates a list of related channels using the metadata associated with those channels or events in those channels. The user can then choose the channels to be displayed in “My Matrix”. A user can also choose from a list of channels that the user's friends have shared. Once the user has selected the channels to appear in “My Matrix” the user can further select the order of the channels to create a default view.

All of the capabilities of the interactive web guide that have been described above can be made available on any device that is connected to the Internet (“connected device”) including, but not limited to, computers, mobile phones, mobile computers, televisions, set top boxes, DVR's, cameras, video cameras, digital audio devices, media servers.

Online Events—Data Record Objects

Online events can be stored in the event profiles database 122 as data record objects that include a start time, one or more online event locations, and one or more elements of metadata about the event. In one embodiment, the start time is adjusted for a viewer's current time zone. Additionally, an end time and/or any recurrence rules or schedules can be included as part of the data record.

The online event location is a URL or other online location identifier where the event can be accessed online through online video, audio, chat, virtual reality, interactive gaming, web browsing, or any other online application or online medium. Alternatively, a placeholder can be used for the event location that is provided prior to or simultaneously with the event start time.

Metadata about the event can include, but is not limited to, descriptive information about the event and attributes such as pricing, duration, permitted audiences, requirements or pre-requisites, agenda, channel or brand, associated show or series, participants, hosts, guests or talent, live status, popularity, attendance, number of RSVPs received in advance, projected audience, relationships to other information or content, other events, people, organizations, places, times, topics, categories, geographic regions, organizations, brands, or concepts.

In one embodiment, additional event object properties can be included. Event objects can be points or intervals. If the event object is a point, it occurs at a specific instant in time with no duration. If the event object is an interval, it has at least some duration. Event objects can be a single event, a recurring regularly scheduled sequence of events, a non-recurring regularly scheduled series of events, or non-recurring irregularly scheduled series or sequences of events.

Event objects can be indivisible or divisible. For example, an event object that is a regularly recurring sequence of events can be divided into separate event objects if there are no requirements for an attendee to attend a previously occurring event in the series.

Event objects can be hierarchically related such that an event can contain events and/or schedules of events. Event objects can be linked to other events, such as related events, repeats, similar events, contained events, events that contain the events, required events, prior events, next events, etc.

Event objects can be linked to particular channels, where channels can represent content providers, brands, shows, topics, editors, users, or special aggregations of events. Event objects can be linked to other information, such as related content, comments, web sites, documents. Additionally, event objects can be linked to related people, organizations, and/or places. Further, event objects can be linked to related advertisements, products, and/or services.

Event objects can contain scheduled sub-events, and each sub-event is also an event object. Containment can be a function of objects literally containing the data that comprises other objects. Alternatively, containment can be denoted by a database record linkage or semantic link that indicates a partonomic relationship between separate event objects.

Hierarchical event objects can be used. For example, a major event such as the Olympics can be made up of sub-events of various sports, such as skiing. The skiing sub-event can, in turn, be made up of other sub-events of various competitions, such as downhill skiing, slalom skiing, etc. Another example of a hierarchical event object is an event called “1,000 Twitter events at noon PST on date x”. This overarching event has 1,000 sub-event objects describing different Twitter events being offered by different Twitter users in that time slot.

Predictive Analytics

A temporal index of the Web associates two or more index elements of online events. Non-limiting examples of index elements of online events include an internet address, time information, and metadata. Internet addresses can take the form of a uniform resource identifier (URI) or uniform resource locator (URL) for the online event. Time information for the online event can take the form of time points (start and/or end times), time intervals, or time patterns such as dates and times, a recurring schedule, or irregular schedule of dates and times. Online event metadata can include information about events happening at certain times with the associated Internet addresses, intended audiences of events, analytics data or metrics about demand, audience, prices, or inventory related to the events, or other addresses or content of any kind related to the events. In one embodiment, online metadata can include advertisements or URLs related to ad campaigns or advertisement network services that are targeted or available at such events.

A temporal index can include, or be used for recording, generating, computing, or relating to, analytics data and other data that provides information for conducting predictive analytics about audience demand and attendance for online events, user behavior with respect to online events, advertisements, or event tickets. The analytics data can be computed solely based on the information in the temporal index, or can be computing based on external information, or a combination of temporal index data and external information.

In some instances, the temporal index can include or be used for generating, computing, or relating to, analytics data and other data that can be useful to advertisers for targeting and optimizing ad buys for online event inventory at various Internet addresses. In one embodiment, the temporal index can include or be used for generating, computing, or relating to, analytics data and other data that can be useful to publishers and/or sellers of online advertising inventory pricing and selling their advertising inventory based on demand and/or demographics for their upcoming online events, and past analytics data about their previous or similar online events.

For example, analytics can be based on the number of people who have sent an RSVP for an event in advance. In one embodiment, these analytics can also be based upon metrics such as the number of people who have viewed information about the event, clicked to go to a page where the event takes place, shared or discussed the event with others, as well as metrics such as the rate at which RSVPs are received for an event or visits to an event in time. By using these metrics, a “rank” or “score” can be calculated or estimated for an event over time. This score can then be used as an indicator of present demand for an online event and future actual attendance of an online event. The rank or score of an event, or the individual metrics that contribute to these scores can also be used to generate reports about events prior to, during, and after the events happen, and to dynamically determine or predict the price of ad inventory or event admission tickets related to the event, over time.

Examples of predictive analytics using the temporal index are given below. By correlating the time series of up-front scores and/or predicted demand metrics for attendance of an event with the actual scores or demand metrics for the event once it takes place, such as actual attendance, advertising sales and rates, or actual ticket prices and sales for an event, it is possible to build a predictive analytics system that improves over time, based on evidence, using machine learning or statistical techniques. Over time-series data sets can generate increasingly accurate predictions of actual event attendance, advertising sales, ticket sales, or prices, based on comparing up-front metrics (of demand, sales, traffic, etc.) to actual metrics once the event takes place, and then improving statistical weights or algorithms in the underlying predictive model based on feedback from the actual results.

Different methods are available for improving the predictive mode, such as using genetic algorithms and statistical models for making predictions and correlations between time-series data sets. These techniques can be applied to compute the attendance, advertising sales, ad prices, ticket sales, or ticket prices, of online events in advance.

Based on the analytics discussed above, various indices of events can be generated which have metrics of interest, such as most popular events, events that are gaining or declining in demand, events which are predicted to have the most valuable ad space, events which are predicted to sell the most tickets, events which are most volatile.

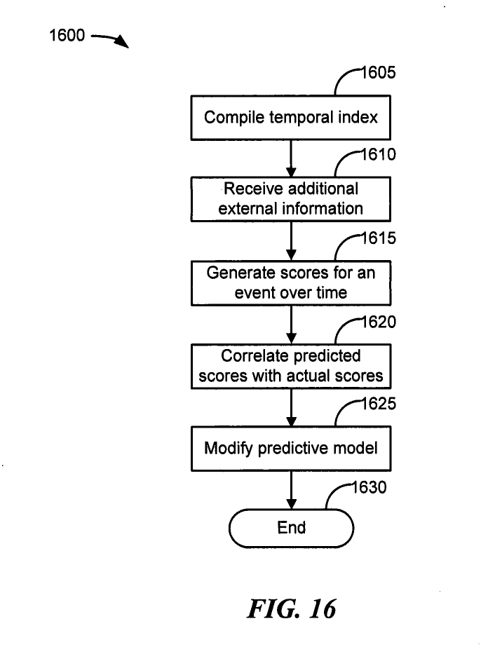

FIG. 16 depicts a flow diagram illustrating an example process of building a predictive analytics system for parameters related to online events. At block 1605, a temporal index is compiled by incorporating online event data from event providers and crawling the Web for online event data.

At block 1610 the system receives additional external information. The additional information can include, but is not limited to, advertisement inventory pricing and advertiser's target audience.

Next, at block 1615, the system uses predictive analytics to generate scores for an event over time. For example, the score can be based on the number of people who have sent an RSVP in advance for an online event, the number of people who have viewed information about the event, and the number of people who have clicked to go a page where the event occurs. The score is used as an indicator of present demand for an online event and future actual attendance of an online event.

After the online event has taken place, data is available for actual event attendance so an actual score for the event can be accurately computed. At block 1620, the system correlates predicted scores with actual scores.

At block 1625, the system modifies the predictive model based upon machine learning and statistical techniques. The modified predictive model can be used to dynamically price and sell tickets and ad inventory for online events. The process ends at block 1630.

In one embodiment, the system enables advertising sellers, such as publishers or content providers, with ad inventory related to online events they provide to dynamically price and sell their ad inventory for online events. The price can be open-ended or can be set with constraints such as a minimum acceptable bid. The price can change based on dynamic demand for the inventory, which can be calculated based on competition among bidders for limited ad inventory, and predicted audience for events based on the predictive analytics methods described above. The price of ad space is a function of availability, competition, and audience. For example, for an event with limited ad inventory, lots of competition for that inventory, and a predicted very large audience, the price could dynamically become quite high compared to an event with limited ad inventory, less competition, and a predicted low audience demand.

In one embodiment, advertisers can buy inventory early to lock in a lower price. In one embodiment, advertisers can enter into binding contracts for a certain ad buy during an event where such contracts are made for a fixed fee. For example, an ad buyer can buy all the ad space at a future online event for $1000, based on predictive analytics that predict an audience of 1000 people at the event. Thus the cost per thousand impressions (CPM) is $1. If the event later turns out to have a smaller audience, the buyer ends up paying a higher CPM. If the event has a larger audience, the buyer ends up getting a lower CPM and thus a better deal. In one embodiment, advertisers can receive “make goods” from ad sellers if the actual audience of an event is less than predicted. In one embodiment, advertisers may have to pay additional fees to ad sellers if the actual audience of an event is greater than predicted. In some instances, advertisers can compete with other bidders for the ad space, driving up the price for an ad buy.

In one embodiment, a series of auctions for future ad inventory on an event take place over time, leading up to the event. For example, the series of auctions can happen hourly or daily in the weeks leading up to an online event. Ad buyers may enter competing bids to buy some or all of the ad space ahead of the event. The advertising seller can accept the winning bids. This creates a market for up-front ad inventory in advance of an event where the price of the inventory changes over time. Buyers who are willing to take more risk may buy (and lock in) ad space far in advance of an event when predictive analytics for event audience are not yet based on a lot of data and are therefore more uncertain. Buyers who are willing to take less risk may wait to buy ad space later, closer to the date and time of an event, where the price they pay is probably higher but is based on a more accurate prediction of event demand. In one embodiment, the system described here enables advertising sellers to dynamically manage, price and run auctions for event-related ad inventory over time.

In some instances, the system provides analytics data, reporting, and market intelligence related to online events.

In one embodiment, users can be profiled based upon participation in online events and/or an online events guide. A person can be ranked according to the number of online events attended in a period of time and/or the length of time online events have been attended and/or the number of friends recruited to participate in online events. A person can also be ranked according to particular events attended based upon the degrees of value the attended events have to advertisers and/or measures of the desirability of a user to advertisers or event providers based on the user's event attendance or RSVP behavior.

In one embodiment, a cookie can be placed in a browser of a user of an online events guide and/or when the user participates in an online event, such that the user can be tracked and the user's participation in online events can be recorded and reported.

Widgets

In one embodiment, widgets are provided that make aspects of the interactive web guide system available for inclusion in external Web sites, on desktops, or within other applications that accept widgets as plug-ins. Widgets can include one or more of the following: a grid or list view of upcoming events showing all events, or any query results or subset of events in the database; My Events showing the events a user has sent an RSVP to and/or attended in the past; My Matrix showing a personal calendar of recommended events or a lineup of user selected and ordered channels; Event Profile—a widget that provides a profile of an event, including optionally a trailer for the event or selected content from the event, information about the content, channel, time, cost, rating, location, projected audience, popularity of the event, etc.; Search Widget used for searching for events in the database; and Channel Profile—a widget that profiles a channel and a set of events that take place on that channel in a period of time.

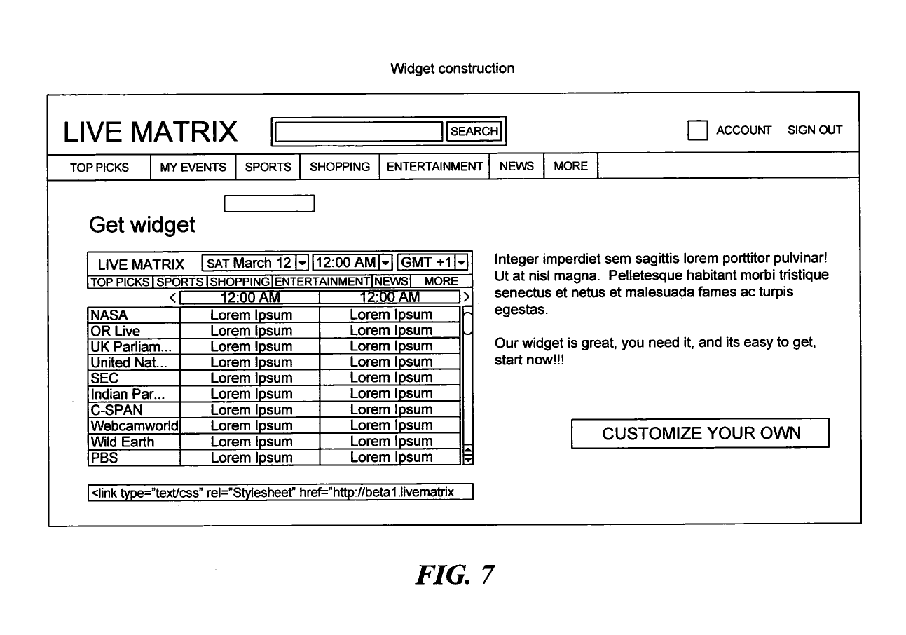

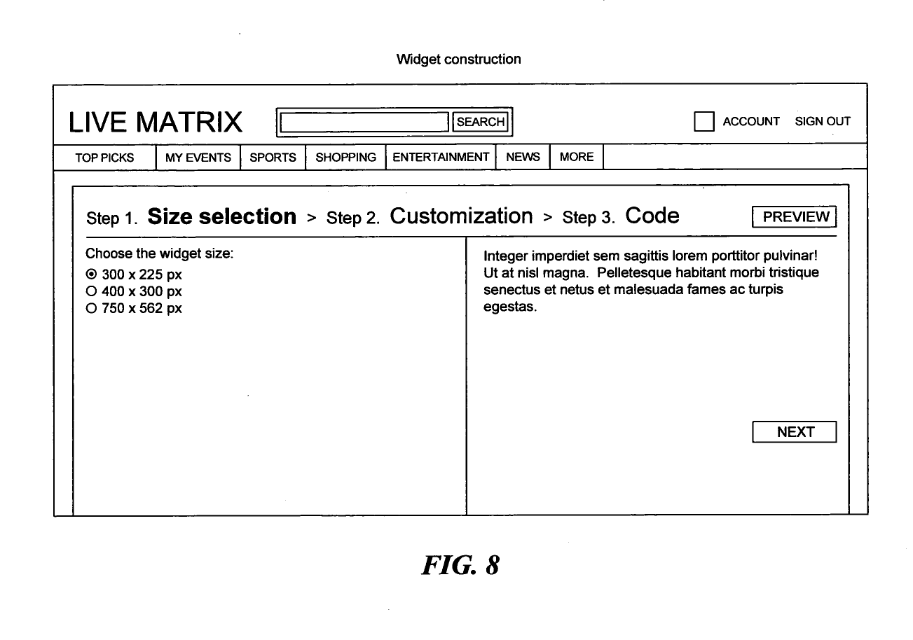

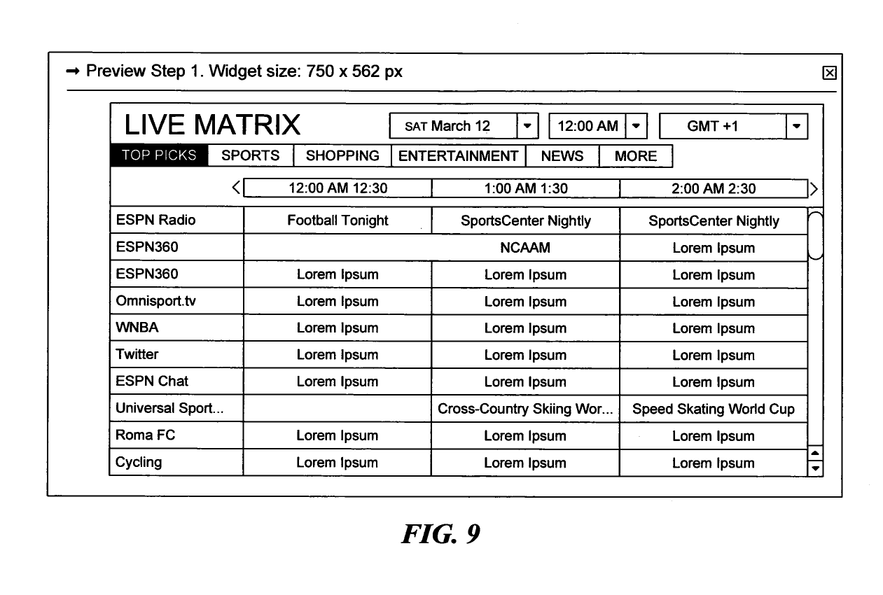

FIG. 7 depicts an example page of an interactive web guide website that allows a user to customize a widget for the interactive web guide. Upon clicking upon the “Customize Your Own” button in FIG. 7, a webpage is displayed that provides size selection of the widget, as shown in the example of FIG. 8. The user is prompted to select a size for the widget. Upon selecting the widget size, a preview of the widget with the selected size is displayed, as shown in the example of FIG. 9.

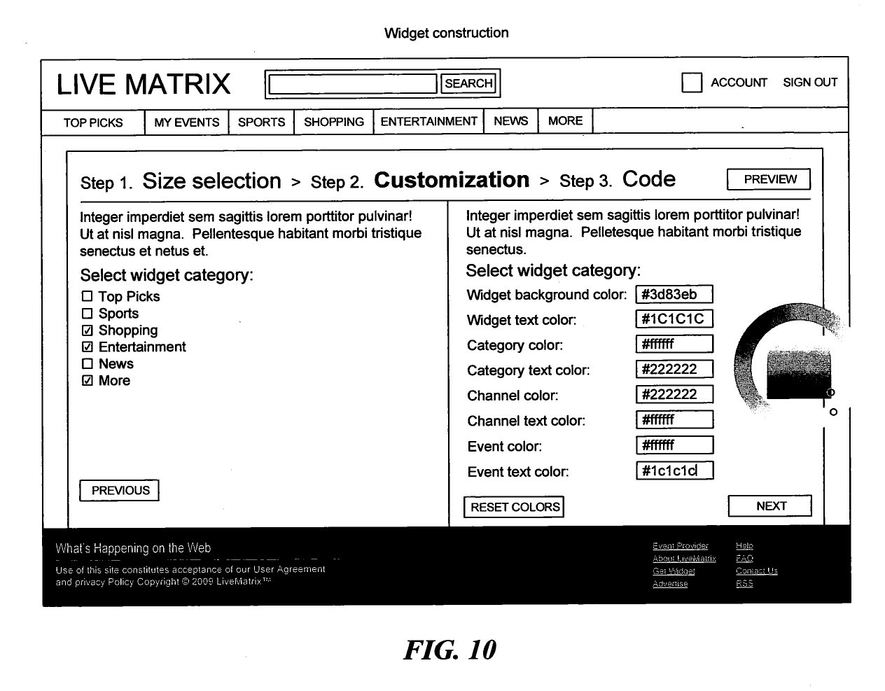

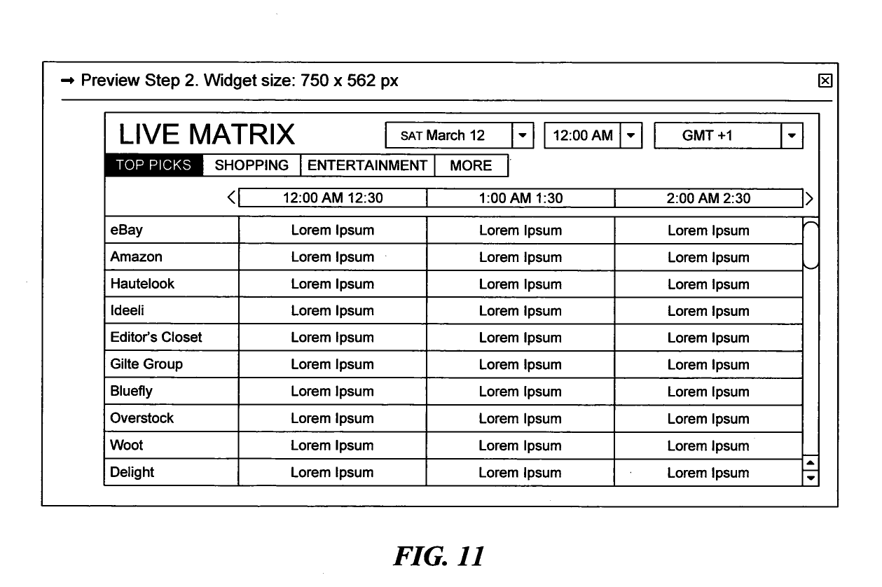

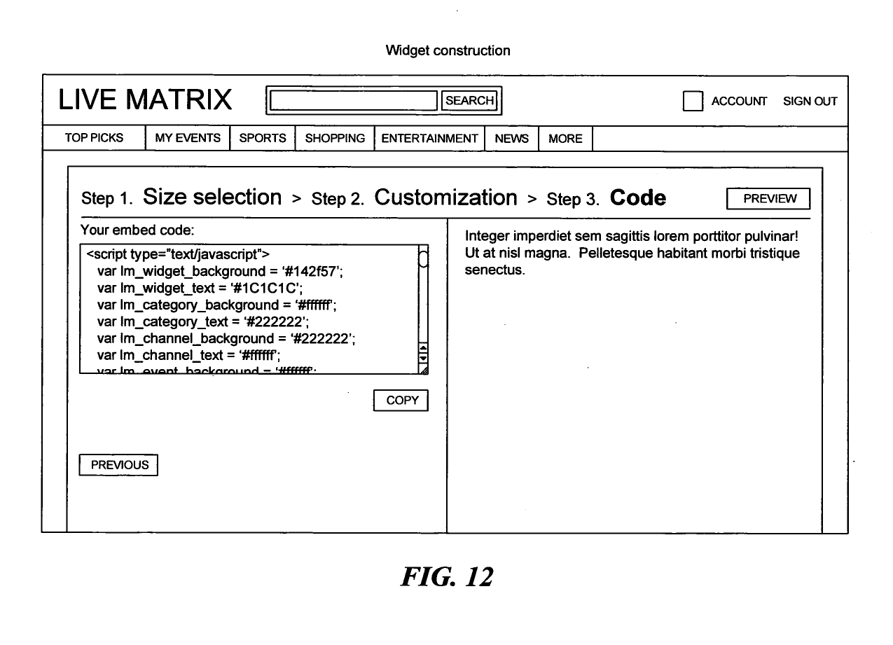

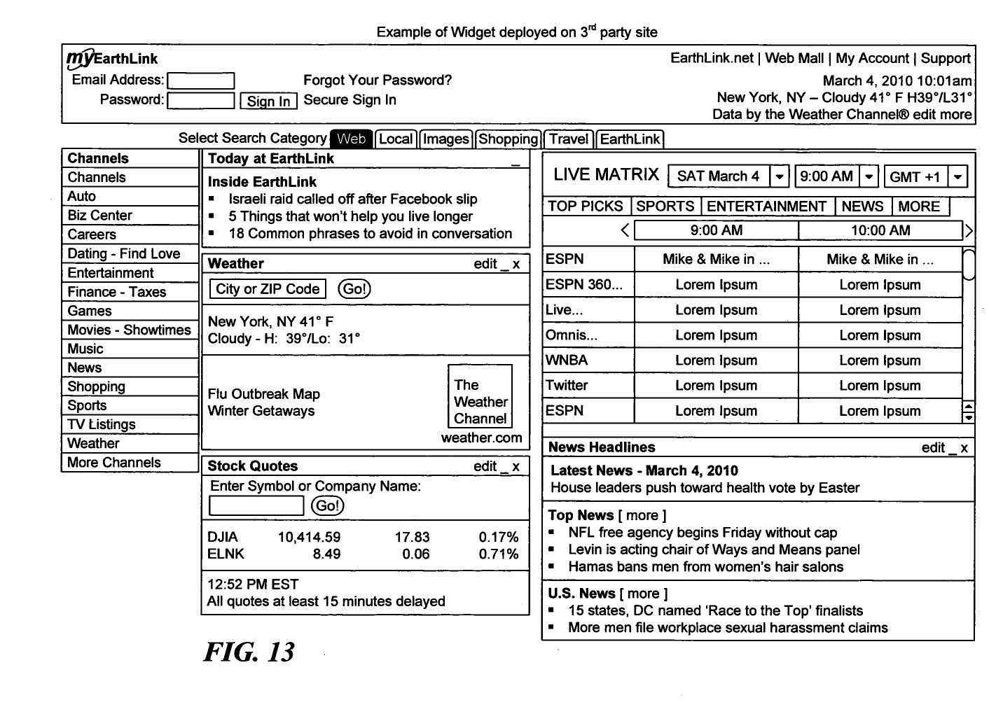

At the next step in customizing the widget, the user is prompted to select the categories to be displayed in the interactive web guide and the color scheme for the widget, as shown in the example of FIG. 10. Upon selecting the categories and color scheme, a preview of the widget with the selected information is displayed, as shown in the example of FIG. 11. Finally, in the example of FIG. 12, a page of the interactive web guide website provides the software code for displaying the customized widget. The user can copy and paste the code into the appropriate location. FIG. 13 depicts an example webpage that displays the interactive web guide widget.

Advertising with the Interactive Web Guide

In one embodiment, advertisements can be shown with the interactive web guide. For example, advertisements can appear surrounding, or within any element of, the user interface. Advertisement can also be inserted into the database so that they travel with any syndicated data through an application programming interface (API) and/or widgets.

Advertisements can be displayed within any format of the interactive web guide in different ways. For example, an advertisement can be displayed between two channels in the interactive web guide. Further, in-grid advertising can be displayed within unscheduled areas within an interactive web guide grid or schedule of online event listings. Additionally, an enhanced event listing with advertisements can be displayed within the interactive guide, grid or schedule of online event listings. An advertisement is shown in an unused area in the example of FIG. 4 in the lower right corner.

Multiple different advertisements can be rotated dynamically or via a schedule or algorithm or as space or time permits within any time slot or advertising location or row in the interactive web guide or schedule.

Temporal Advertising on the Web

Many large online event providers and advertising networks or marketplaces do not know how to price advertising inventory around or within online events because it is unknown if and when the online events are scheduled, and it is unknown who the projected audience is or who the audience is comprised of. Consequently, it is difficult to dynamically price advertisements based on projected audience or on the market for desired timeslots at particular locations.

By using predictive analytics about historical and projected online event attendance in conjunction with the database of scheduled upcoming online events, it is possible to dynamically target price, and run and measure temporal ad campaigns on the Internet. Without a calendar of upcoming online events it is difficult to ascertain the existence of temporal inventory and how to price that inventory. For example, the interactive web guide database may provide information that there is a large upcoming online soccer match involving Manchester United where four million people with desirable demographics are projected to attend. Further, based on the internet protocol (IP) addresses of user who have sent in RSVPs, it is possible to geosegment and/or geotarget the audience. This information can be used to intelligently buy, sell, price, manage, target, and optimize online advertising campaigns to coincide with that event on the event site location as well as on other sites that may be related to the event or near it. For example, in advertising in conjunction with the Manchester United soccer match, Nike can advertise a new soccer shoe that is about to be released worldwide and use Wayne Rooney in ads that may be displayed to a European online audience while using Ji Sung Park for ads related to the event when viewed by an online user in South Korea. Further, ESPN might buy advertising campaigns to buy advertising leading up to or during the event to promote another soccer webcast that is to take place 30 minutes after the conclusion of the current Manchester United soccer webcast.

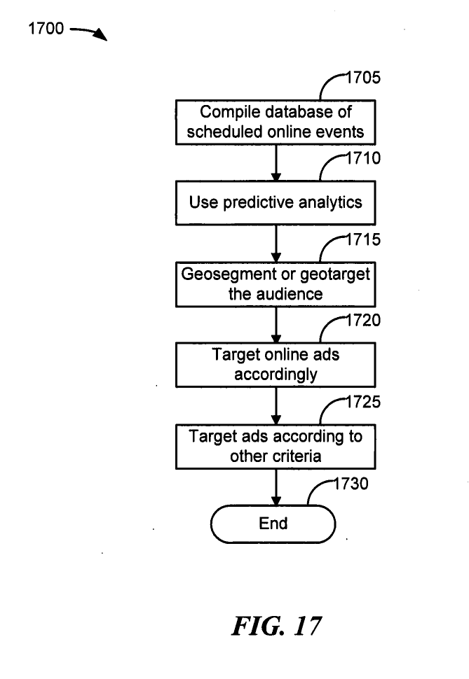

FIG. 17 depicts a flow diagram illustrating an example process of optimizing temporal advertising on the Web. Temporal advertising is a method of buying, selling, and targeting online advertisements to run in particular time periods as well as targeting advertisements according to other criteria, such as targeted keywords, targeted inventory on particular locations such as web sites or web pages, targeted audience demographics, and user-profiles. Temporal advertising applies to any Web site, software application, online service, or online ad inventory, not just to event-related content or a website that hosts the interactive web guide. Online temporal advertising is broadly applicable to all online advertising.

At block 1705, the system compiles a database of scheduled online events, such as event profiles database 122. Then at block 1710, the system uses predictive analytics about past and projected online event attendance to dynamically target price for the event.

At block 1715, the system uses the database of scheduled online events with the projected online event attendance to geosegment and/or geotarget the audience. This audience information is used at block 1720 to target online ads to the particular audience demographic. At block 1730, advertisements can also be targeted according to other criteria, such as keywords or web page locations. The process ends at block 1730.

Ads may be scheduled for exact times (e.g., noon), or within time ranges (e.g., between 11 and noon), or sets of time periods (e.g., a recurring schedule of exact times or time ranges), or for named periods (e.g., Christmas or Winter), or for pre-set periods preceding, during or after an event (e.g., 30 minutes prior to the start of an event, for the last 15 minutes of an event, or for the first 30 minutes following the conclusion of an event).

Ads may also be scheduled to coincide with a particular time and/or particular targeted online events (e.g., particular online concert, a basketball event featuring a player such as Kobe Bryant, and events by ESPN), online events with desired attributes (e.g., any comedy events), or online events that cater to specific desired audiences, without specifying exact times. The ads can be programmed to run whenever qualifying targeted events occur in time.

Temporally targeted ads can be priced by time slot and location. Pricing can be fixed price or variable based on demand for a given time slot and location. An advertisement may cost more to run in a certain time slot during peak hours on some websites or during a popular online event at a certain website. For an online event particular ad inventory may be defined temporally (before, during, after the event, or at specific times during the event). Pricing can change dynamically to reflect dynamically changing demand over time.

Temporally targeted advertising can be displayed on a Web page either within time frames or at desired time frames. Moreover, temporally targeted advertising can appear before, simultaneously with, or after an online event during that event, and/or it may appear on an interactive guide, grid or schedule of online event listings at specified times.

An online or offline marketplace may be provided where online temporally targeted ad inventory is bought and sold by auction and/or traded. A system for buying and selling advertising in one or more online inventory locations based upon particular desired temporal periods can be provided to buyers and sellers. Further, temporal advertising campaign management tools help to provide ad buyers and ad sellers with tools to service campaigns and report on results.

In one embodiment, a temporally targeted online advertising campaign can be adjusted to run in different but equivalent time periods in different time zones. For example, if a campaign is targeted to run at 8:00 pm time slots, the advertising would run at 8:00 pm in all selected time zones, such as Pacific Standard Time (PST), Eastern Standard Time (EST), etc. Thus, instead of running at a single global time, the advertising would run at the desired relative time slot in each time zone.

In one embodiment, a system for selling temporally defined advertising units online can be implemented. For example, a specific web site may indicate that temporal advertising opportunities are sold in five minute blocks. Advertisers may purchase five minute blocks during which their ads may appear as the only ad, or may appear with some frequency or level of visibility depending on price and demand for advertising during that block of time. Multiple advertisers may advertise in the same block. Advertising campaigns may be targeted to run in different blocks with different frequency distributions. Advertising campaign management systems may intelligently seek to optimize advertising campaigns across temporal blocks to optimize for budget or performance constraints of buyers and sellers.

Landing Web Pages

In one embodiment, event landing pages are provided to event providers for their events. Channel landing pages for sets of events that take place on a channel can also be provided to event providers.

Landing pages provide online locations for events, including capabilities for showing live streaming video or audio, providing interactive chat, selling tickets, controlling audience participation, archiving previous events, showing calendars, running advertising, providing descriptive data and metadata, running recommendations, adding custom branding and design elements, and administering content, live events, and user participation.

Event Data API

In one embodiment, the interactive web guide provides an application programming interface (API) that enables external parties to publish and subscribe to the event profiles database 122 and/or the temporal index database 124, and/or the user database 126 and to search the database. The API enables the external parties to add event data, get event data, and to conduct searches of databases maintained by the interactive web guide from their applications, provided the external parties have received permission to access the database.

In one embodiment, the API can enable external applications to connect with and access user profile data, analytics data and reports, with permission. In one embodiment, the API can enable external applications to buy or sell advertising within the interactive web guide, and to administer advertising campaigns within interactive web guide content.

FIG. 18 shows a diagrammatic representation of a machine in the example form of a computer system 1800 within which a set of instructions, for causing the machine to perform any one or more of the methodologies discussed herein, may be executed.

In the example of FIG. 18, the computer system 1800 includes a processor, memory, non-volatile memory, and an interface device. Various common components (e.g., cache memory) are omitted for illustrative simplicity. The computer system 1800 is intended to illustrate a hardware device on which any of the components depicted in the example of FIG. 1B (and any other components described in this specification) can be implemented. The computer system 1800 can be of any applicable known or convenient type. The components of the computer system 1800 can be coupled together via a bus or through some other known or convenient device.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory can include, by way of example but not limitation, random access memory (RAM), such as dynamic RAM (DRAM) and static RAM (SRAM). The memory can be local, remote, or distributed.

The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer 1800. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The network interface can include one or more of a modem or network interface. It will be appreciated that a modem or network interface can be considered to be part of the computer system 1800. The interface can include an analog modem, isdn modem, cable modem, token ring interface, satellite transmission interface (e.g. “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted in the example of FIG. 18 reside in the interface.

In operation, the computer system 1800 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

### CONCLUSION

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or subcombinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶ 6 will begin with the words “means for.”) Accordingly, the applicant reserves the right to add additional claims after filing the application to pursue such additional claim forms for other aspects of the invention.

We claim:

1. An system, comprising:
an event profile database configured to store data relating to a plurality of online events;
an event provider module configured to receive first data about online events from a plurality of event providers, wherein the first data is stored in the event profile database;
a web mining module configured to search for second data about online events on the World Wide Web, wherein the second data is stored in the event profile database;
a display module configured to present to a user at least some of the first data and the second data stored in the event profile database in an organized format as an interactive guide;
a response module configured to receive input from the user pertaining to the interactive guide and to respond to the input, wherein the input effects a content or format of the presented interactive guide.

2. The system of claim 1, wherein the data stored in the event profile database includes a location of an online event, a time parameter of the online event, and metadata pertaining to the online event.

3. The system of claim 1, further comprising a widget module configured to receive widget customization parameters and generate code for a customized widget to enable the interactive guide to be installed and executed within a web page.

4. The system of claim 1, further comprising:
a temporal index database configured to store indices of online events, wherein the indices include an internet address of an online event, time information for the online event, metadata pertaining to the online event, wherein at least some of the indices are obtained from the event profile database;
a predictive analytics module configured to generate a score for an online event based upon the online event's indices, wherein the score is an indicator of present demand for the online event and future attendance of the online event.

5. The system of claim 4, wherein the score is used to dynamically determine or predict a price for advertising inventory to be displayed with the interactive guide.

6. The system of claim 4, wherein the score is used dynamically determine or predict a price of admission tickets to the online event.

7. The system of claim 4, further comprising:
an advertisements database configured to store advertisements and advertisement pricing information,
an advertising module configured to receive advertisements from the advertisement database for placement in the interactive guide and use predictive analytics data to optimize advertising campaigns.

8. The system of claim 7, wherein the organized format is a grid format, rows represent content channels, and columns represent time slots, and further wherein an advertisement is placed within one or more rows in the grid.

9. The system of claim 7, further comprising an application programming interface (API), wherein the API enables parties to access the data in the event profile database, buy or sell advertising within the interactive guide, and administer advertising campaigns within interactive guide content.

10. The system of claim 4, wherein the input from the user is a command to send a response indicating intent to attend a particular online event, and the response is stored in the temporal index database.

11. The system of claim 1, wherein the organized format of the interactive guide is a grid, list, or timeline.

12. The system of claim 1, wherein the input from the user is a command to search for online events related to a specified topic.

13. The system of claim 1, wherein the input from the user is a command to add an event to the user's personal events.

14. The system of claim 1, wherein the input from the user is a command to sort the presented data.

15. A method, comprising:
acquiring data pertaining to online events;
causing to be displayed on a user's display the acquired data in a first format as an interactive guide, wherein a user can send a request relating to displayed content or format of the interactive guide;
receiving the user's request;
responding to the user's request.

16. The method of claim 15, wherein the acquired data includes an online location for an event, a time for the event, and metadata about the event.

17. The method of claim 15, wherein acquiring data comprises receiving a first data from event providers and searching the Web for a second data.

18. The method of claim 15, further comprising receiving advertisements for placement in the interactive guide.

19. The method of claim 18, further comprising:
receiving advertising data from advertisers;
creating a temporal index from the acquired data and the advertising data;
generating from the temporal index and advertising data analytics data pertaining to audience demand and attendance for online events;
selecting placements for the advertisements in the interactive guide based upon the analytics data.

20. The method of claim 19, wherein advertising data includes advertisement inventory pricing and a target audience.

21. The method of claim 19, wherein the user's request includes one of the following: selecting one or more elements of the displayed data to obtain related data; changing the first format of the displayed data; requesting data related a specified topic; selecting a standard category of online event to be displayed; going to a selected online event; and requesting a reminder for a particular online event; and intent to attend a selected online event.

22. A method, comprising:
compiling by a server a temporal index database configured to store indices of online events;
using a predictive model by the server to generate a predictive score for an online event over time using the predictive model and indices from the temporal index database;
correlating by the server the predictive score with an actual score;
modifying by the server the predictive model based upon the correlation,
using the modified predictive model by the server to dynamically price tickets and advertising for future online events.

23. The method of claim 22, wherein the indices include an internet address of an online event, time information for the online event, metadata pertaining to the online event.

24. The method of claim 22, wherein generating predictive scores comprises using information about a first number of people who send a response in advance for attending the online event, a second number of people who have viewed information about the online event, a third number of people who have clicked to go to a web page where the online event occurs, a fourth number of people who have shared or discussed the online event with others, a first rate at which responses are received in advance for attending the online event, and a second rate at which visits are made to the online event.

25. The method of claim 22, wherein modifying the predictive model comprises using machine learning.

26. The method of claim 22, wherein modifying the predictive model comprises using statistical models.

27. The method of claim 22, wherein modifying the predictive model comprises using genetic algorithms.

28. A method, comprising:
compiling by a server a temporal index database configured to store indices of online events;
using predictive analytics about historical and projected attendance to an online event by the server to dynamically target ticket prices as a function of time for the online event;
selling by the server tickets to the online event based upon dynamic pricing.

29. A method, comprising:
compiling by a server a temporal index database configured to store indices of online events;
using predictive analytics about historical and projected attendance to an online event and information about people who sent a response indicating intent to attend the event by the server to geotarget an audience for the online event;
targeting by the server an online advertising campaign based upon the geotargeting information.

30. The method of claim 29, wherein the information about people who sent a response comprises internet protocol (IP) addresses of the people.

31. The method of claim 29, further comprising targeting the online advertising campaign further based upon other criteria.

32. The method of claim 31, wherein the other criteria include targeted keywords, targeted inventory on particular webpages, targeted audience demographics, and user profiles.

33. The method of claim 29, wherein targeting online advertising campaigns comprises scheduling the advertising campaign to occur at an exact time, within time ranges, during specified time periods, at a first set of pre-set periods preceding an online event, at a second set of pre-set periods during an online event, at a third set of pre-sent periods after an online event, during a particular targeted online event, during online events with specified attributes, or during online events that appeal to a particular audience demographic.

34. The method of claim 33, wherein the advertising campaign is adjusted to run at an equivalent specified time in different time zones.

35. A computer-readable medium encoded with processing instructions for implementing a method performed by a computer, the method comprising:
acquiring data pertaining to online events;
causing to be displayed on a user's display the acquired data in a first format as an interactive guide, wherein a user can send a request relating to displayed content or format of the interactive guide;
receiving the user's request;
responding to the user's request.

36. The compute-readable medium of claim 35, further comprising:
receiving advertising data from advertisers;
creating a temporal index from the acquired data and the advertising data;
generating from the temporal index and advertising data analytics data pertaining to audience demand and attendance for online events;
selecting placements for the advertisements in the interactive guide based upon the analytics data.
